(19) United States
(12) Patent Application Publication
(10) Pub. No.: US 2009/0244391 A1
(43) Pub. Date: Oct. 1, 2009

(54) Electronic Apparatus and Control Method of Electronic Apparatus

(75) Inventors: Hiroshi Kitami, Fukaya-shi (JP); Toshiyasu Tamura, Kumagaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/405,080

(22) Filed: Mar. 16, 2009

(30) Foreign Application Priority Data
Mar. 28, 2008 (JP) 2008-087759

(51) Int. Cl. H04N 5/268

(52) U.S. Cl. 348/705; 348/E05.057

(57) ABSTRACT

According to one embodiment, an electronic apparatus includes a plurality of ports configured to be inserted a one end of a cable having a first signal line for performing first data communication and a second signal line, respectively, a communication module configured to perform the second data communication via the with an external apparatus having a function to perform the second communication, a communication line configured to connect the second signal line in the cable whose one end inserted into the each port and the communication module with each other in a wired-OR manner, a plurality of switches provided on the communication line, configured to perform switching between on and off of electrical connection between the second signal line in the cable connected to the each port and the communication module independently, and a control module configured to perform switching between on and off of the each switch independently.

### CROSS-REFERENCE TO RELATED APPLICATIONS

This application is based upon and claims the benefit of priority from Japanese Patent Application No. 2008-087759, filed Mar. 28, 2008, the entire contents of which are incorporated herein by reference.

### BACKGROUND

1. Field

One embodiment of the present invention relates to an electronic apparatus and a control method of an electronic apparatus.

2. Description of the Related Art

Currently, use of High-Definition Multimedia Interface (HDMI) Standards is accelerated for transmission of video signal an audio signal between a television set and a recording apparatus.

In HDMI Standard, Consumer Electronics Control (CEC) Standard (see “High-Definition Multimedia Interface Specification Version 1.3a” Hitachi, Ltd./Matsushita Electric Industrial Co., Ltd./Philips Consumer Electronics, International B. V./Silicon Image, Inc./Sony Corporation/Thomson Inc./Toshiba Corporation, Nov. 10, 2006) is defined as an option. The CEC Standard is a serial communication protocol which allows mutual control between HDMI connection apparatuses via a terminal (CEC terminal) contained in HDMI terminals.

A CEC line transmitting a CEC command between a source apparatus and a sink apparatus is connected to a microcomputer on the source side via a wired-OR. In the connection, when abnormality occurs in a CEC line of one of HDMI apparatuses configuring a system, mutual control function in all apparatuses contained in the system does not serve.

### BRIEF DESCRIPTION OF THE SEVERAL VIEWS OF THE DRAWING

FIG. 1 is an exemplary schematic diagram showing an HDMI system according to one embodiment of the present invention;

FIG. 2 is an exemplary block diagram showing a configuration of the HDMI system according to one embodiment of the present invention;

FIG. 3 is an exemplary block diagram showing a configuration of a television set according to one embodiment of the present invention;

FIG. 4 is an exemplary flowchart showing a procedure of a processing for detecting a failed CEC control line to break the detected CEC control line according to one embodiment of the present invention; and

FIG. 5 is an exemplary diagram showing a display screen for allowing a user to perform manual switching between on and off.

### DETAILED DESCRIPTION

Various embodiments according to the invention will be described hereinafter with reference to the accompanying drawings. In general, according to one embodiment of the invention, an electronic apparatus comprises a plurality of ports configured to be inserted a one end of a cable having a first signal line for performing first data communication and a second signal line, respectively, and other end of the cable inserted into a port provided in the external apparatus having a function to perform at least first data communication a communication module configured to perform the second data communication via the cable whose one end being inserted into any port of the plurality of ports with an external apparatus having a function to perform the second communication a communication line configured to connect the second signal line in the cable whose one end inserted into the each port and the communication module with each other in a wired-OR manner a plurality of switches provided on the communication line, and configured to perform switching between on and off of electrical connection between the second signal line in the cable connected to the each port and the communication module independently and a control module configured to perform switching between on and off of the each switch independently.

### First Embodiment

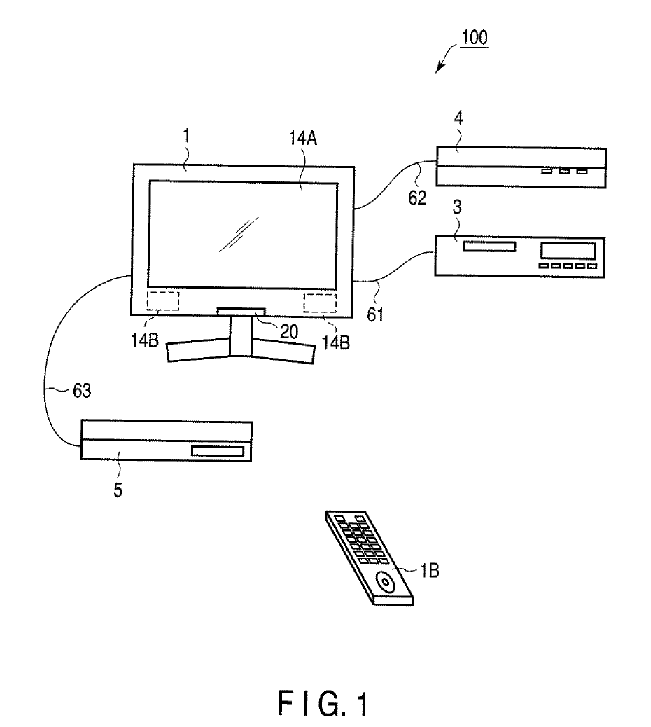

FIG. 1 is a schematic diagram showing an HDMI (High-Definition Multimedia Interface) system according to a first embodiment of the present invention.

An HDMI system 100 includes a television set 1 which is an electronic apparatus receiving a terrestrial digital broadcast wave from an antenna, demodulating, and displaying the same, or receiving a video signal from an external input to display the same, a DVD player 3 which plays media such as a High-Definition Digital Versatile Disc (HD DVD) or a DVD, a set-top box 4 which serves as a tuner receiving satellite broadcasting such as direct broadcasting by satellite (DBS) to demodulate the same, and a hard disc drive (HDD) recorder 5 which can record a video signal from broadcasting or external input to output recorded content to the outside, and it is configured by connecting these apparatuses using HDMI cables 61, 62, and 63, as illustrated, respectively. A remote controller 1B is an exclusive remote controller for operating the television set 1 but it can transmit command signals to the other electronic apparatuses via the HDMI cables 61, 62, and 63 to operate them.

The television set 1 confirms connections with the respective electronic apparatuses performed via the HDMI cables 61, 62, and 63 at a power-on time of the television set 1 and further confirms the same periodically during normal operation of the television set 1. Transmission and reception of information about connection confirmation is performed using CEC control lines of the HDMI cables 61, 62, and 63.

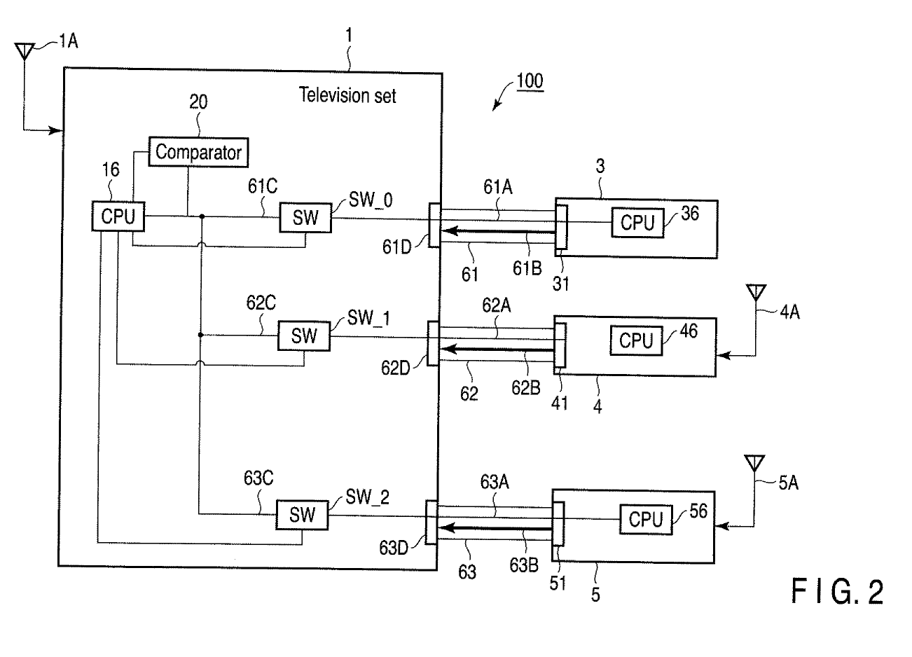

FIG. 2 is a block diagram showing a configuration of the HDMI system according to the first embodiment of the present invention.

As shown in FIG. 2, television set 1 includes a first receptacle 61D, a second receptacle 62D, and a third receptacle 63D of the HDMI terminals. A plug at one end of the HDMI cable 61 is inserted into the first receptacle 610 of the television set 1, while a plug at the other end of the HDMI cable 61 is inserted into a receptacle 31 of the DVD player 3. A plug at one end of the HDMI cable 62 is inserted into the second receptacle 62D of the television set 1, while a plug at the other end of the HDMI cable 62 is inserted into a receptacle 41 of the set-top box 4. A plug at one end of the HDMI cable 63 is inserted into the third receptacle 63D of the television set 1, while a plug at the other end of the HDMI cable 63 is inserted into a receptacle 51 of the HOD recorder 5.

The television set 1 receives a terrestrial digital broadcast wave via an antenna 1A. The set-top box 4 receives a DBS broadcast wave via an antenna 4A. The HDD recorder 5 receives a terrestrial digital broadcast wave via an antenna 5A.

The HDMI cables 61, 62, and 63 include Consumer Electronics Control (CEC) control lines 61A, 62A, and 63A, and HDMI lines 61B, 62B, and 63B. The CEC control lines 61A and 63A connect CPUs 16, 36, 46, and 56 in the respective electronic apparatuses serially via the CEC control lines 61C and 63C in the television set 1. The HDMI lines 61B, 62B, and 63B connect the television set 1 to the respective electronic apparatuses so as to perform transmission of video signal and audio signal.

One ends of the CEC control lines 61C, 62C, and 63C in the television set 1 is connected to the respective receptacles 61D, 62D, and 63D in a wired-OR manner, while the other ends thereof are connected to the CPU 16. Switches SW_0 to SW_2 for performing switching between on and off of electrical connections between the respective receptacles 61D, 62D, 63D and the CPU 16 independently are inserted in the CEC control lines 61C, 62C, and 63C. Switching between on and off of the switches SW_0 to SW_2 is performed by the CPU 16.

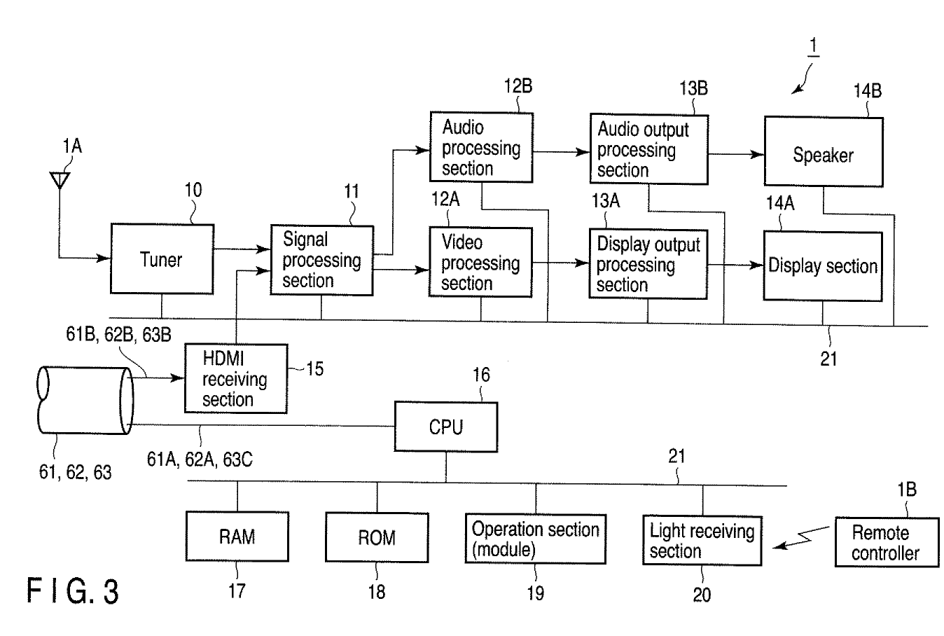

FIG. 3 is a block diagram showing a configuration of the television set according to the first embodiment of the present invention.

The television set 1 includes a tuner 10 which receives a terrestrial digital broadcast wave (broadcasting signal) via the antenna 1A to demodulate the broadcast wave and output a program signal, a signal processing module 11 which processes outputs from the tuner 10 for each of video data, audio data, caption data, and the like, a video processing module 12A which decodes outputs of video data and caption data from the signal processing module 11, a display processing module 13A which converts output from the video processing module 12A to video signal for display to output the same, a display device 14A which displays output from the display processing module 13A on a liquid crystal display (LCD), an audio output processing module 12B which decodes output of audio data from the signal processing module 11, an audio output processing module 13B which converts output from the audio output processing module 12B to an audio signal to output the same, a speaker 14B which converts output from the audio output processing module 13B to audio, an HDMI receiving module 15 which receives video data and audio data from the outside via the HDMI lines 61B, 62B, and 63B of the HDMI cables 61, 62, and 63, a central processing unit (CPU) 16 which transmits/receives CEC control data to/from the outside via the CEC control lines 61C, 62C, and 63C of the HDMI cables 61, 62, and 63 to control respective sections in the television set 1, a random access memory (RAM) 17 which stores data to be processed by the CPU 16 temporarily, a read-only memory (ROM) 18 which records data in a non-volatile manner, such as a firmware, an operation module 19 which includes a plurality of switches, and the like and operates the television set 1 based upon inputs in the switches, and a light receiving section 20 which receives an instruction using infrared signal from the remote controller 1B. The respective sections of the television set 1 are mutually connected via a bus 21.

Incidentally, the HDMI cables 61, 62, and 63 are connected to the HDMI receiving module 15 and the CPU 16 via an interface of HDMI connected to receptacles (not shown), respectively.

Now, as shown in FIG. 2, the set-top box 4 corresponds to transmissions of video signal and audio signal, but it is non-compliant to the CEC Standard, where the CEC control line 62A and a CPU 46 are not connected to each other. Now, the CEC control line 62A of any of apparatuses non-compliant to the CEC Standard is connected to the ground (GND). When the CEC control line 62A is connected to the ground, transmission of a CEC command cannot be performed between the television set 1 and the DVD player 3 or between the television set 1 and the HOD recorder 5. Even when abnormality occurs in the CEC control line in a connected external apparatus, transmission of a CEC command cannot be performed between the CEC control line and a normal external apparatus.

In the television set 1, even if the set-top box 4 connects the CEC control line 62A to the ground or abnormality occurs in the CEC control line, which results in trouble regarding transmission of a CEC command, communication with the other apparatuses 3 and 5 can be performed reliably.

Specifically, when the set-top box 4 connects the CEC control line 62A to the ground, the switch SW_1 inserted in the CEC control line 62C electrically connected to the CEC control line 62A is turned off automatically.

(Failed CEC Control Line Automatic Detection/Breaking Processing)

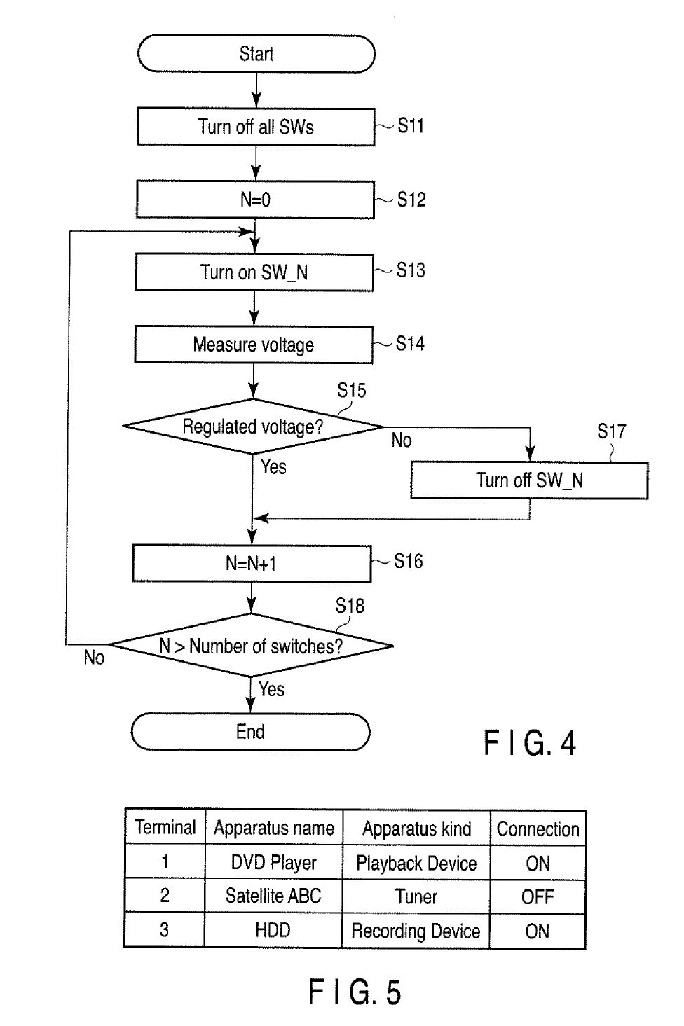

A method for detecting an apparatus connecting a CEC control line to the ground to break the CEC control line of the detected apparatus automatically will be explained with reference to a flowchart in FIG. 4.

First, the CPU 16 turns off all the switches SW_0 to SW_2 (Block S11). Next, the CPU 16 sets number N for designating a switch to 0 (Block S12). Next, the CPU 16 turns on switch SW_N (Block S13). A comparator 20 determines whether or not voltages of the CEC control lines 61C, 62C, and 63C are in a range of the electrical specification of CEC in a state that Hi has been outputted from the CPU 16 to the CEC control lines 61C, 62C, and 63C to output the determination result to the CPU 16 (Block S14). An output voltage when Hi is outputted is regulated to fall in a range of 2.5 to 3.63V in the electrical specification of CEC. Accordingly, the comparator 20 makes determination about whether or not the measurement voltage falls in a range of 2.5 to 3.63V.

The CPU 16 determines whether or not the voltages of the CEC control lines 61C, 62C, and 63C fail in the regulated range of the electrical specification from the determination result in the comparator 20 (Block S15). When the CPU 16 determines that the voltages do not fall in the regulated range (NO in Block S15), it can be determined that the apparatus connected to the switch SW_N connects the CEC control line to the ground, so that the CPU 16 turns off the switch SW_N (Block S17).

When the CPU 16 determines that the voltages fall in the regulated range (YES in Block S15) or after the switch SW_N is turned off (Block S17), the CPU 16 increments the value of N by +1 (Block S16). The CPU 16 determines whether or not the value of new N is larger than the number of switches (2 in this embodiment) (Block S18).

When the CPU 16 determined that the value of new N is not larger than the number of switches (NO in Block S18), the CPU 16 sequentially performs the processing from block S13. When the CPU 16 determines that the value of new N is larger than the number of switches (YES in Block 518), the CPU 16 terminates the processing.

In order to sequentially perform switching among the switches SW_0 to SW_2 inserted in the CEC control lines 61C, 62C, and 63C to determine whether or not a problem occurs in communication of a CEC command in the abovementioned processing, whether or not there is a problem with the CEC control lines 61C, 62C, and 63C is examined and a switch for performing switching of electrical connection between a problematic one of the examined CEC control lines 61C, 62C, and 63C and the CPU 16 is turned off, so that a port connected with a problematic external apparatus is broken and transmission and reception of a CEC command can be performed via the CEC control line connected with a normal apparatus.

(Manual Breaking Processing)

Such a configuration can be adopted that a menu such as shown in FIG. 5 is displayed by the CPU 16 and a user can select on or off of a switch on the CEC line from the menu arbitrarily. When the user conducts input operation of the remote controller 1B, the light receiving section 20 detects the operation of the remote controller 1B to output the detection result to the CPU 16. The CPU 16 changes display of the menu according to user's input operation and performs switching on or off of the switches SW_0 to SW_2.

(Periodical Failed CEC Control Line Automatic Detection/Breaking Processing)

Such a configuration can be adopted that, after power is turned on, whether or not voltages of the CEC control lines 61C, 62C, and 63C fall in the regulated voltage range is examined periodically, so that presence/absence of abnormality in the CEC control lines 61C, 62C, and 63C is detected, the processing explained with reference to the flowchart in FIG. 4 is performed if a problem is found, and a CEC control line connected with an problematic external apparatus is broken.

The abovementioned “failed CEC control line automatic detection/breaking processing”, “manual breaking processing”, and “periodical failed CEC control line automatic detection/breaking processing” may be combined. When the combination is adopted, regarding on/off setting of the switches SW_0 to SW_2 on the CEC control lines 61C, 62C, and 63C, setting of a method implemented temporally at the end comes first.

A TV such as described in the embodiment can avoid such a problem that mutual control function between the TV and all HDMI source apparatuses having HDMI CEC function, connected to the TV is disabled due to connection of an HDMI source apparatus including a problematic CEC control line conforming to the HDMI Standard.

In the embodiment described above, the example of the television set which is a sink apparatus has been adopted as the electronic apparatus, but the electronic apparatus may be such a source apparatus as a DVD player, a set-top box, or a DVD recorder, or an HDMI selector.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a plurality of ports configured to be inserted a one end of a cable having a first signal line for performing first data communication and a second signal line, respectively, and other end of the cable inserted into a port provided in the external apparatus having a function to perform at least first data communication;
a communication module configured to perform the second data communication via the cable whose one end being inserted into any port of the plurality of ports with an external apparatus having a function to perform the second communication;
a communication line configured to connect the second signal line in the cable whose one end inserted into the each port and the communication module with each other in a wired-OR manner;
a plurality of switches provided on the communication line, and configured to perform switching between on and off of electrical connection between the second signal line in the cable connected to the each port and the communication module independently; and
a control module configured to perform switching between on and off of the each switch independently.

2. The electronic apparatus of claim 1, wherein, while the control module sequentially turns on the plurality of switches after turning off the each switch, the control module determines whether or not communication failure occurs in the second data communication with an external apparatus connected to a port corresponding to the switch turned on via the cable and turns off a switch corresponding to a port connected with an external apparatus where it has been determined that communication failure occurs via the cable.

3. The electronic apparatus of claim 1, wherein the control module displays a setting screen for setting on or off of the each switch, detects setting of on or off of the each switch which a user uses the setting screen to input, and performs switching between on and off of the each switch according to the detected setting.

4. The electronic apparatus of claim 1, wherein video signal is transmitted from the external apparatus to the electronic apparatus, and
the apparatus further comprises a display device configured to display video corresponding to the video signal is further provided.

5. The electronic apparatus of claim 1, wherein the first data communication is performed based upon HDMI Standard, and the second data communication is performed based upon CEC Standard of HDMI Standard.

6. A control method of an electronic apparatus corresponding to first data communication and second data communication, where the electronic apparatus comprising:
a plurality of ports configured to be inserted a one end of a cable having a first signal line for performing first data communication and a second signal line, respectively, and other end of the cable inserted into a port provided in the external apparatus having a function to perform at least first data communication;
a communication module configured to perform the second data communication via the cable whose one end being inserted into any port of the plurality of ports with an external apparatus having a function to perform the second communication;
a communication line configured to connect the second signal line in the cable whose one end inserted into the each port and the communication module with each other in a wired-OR manner; and
a plurality of switches provided on the communication line, configured to perform switching between on and off of electrical connection between the second signal line in the cable connected to the each port and the communication module independently, and
the control method comprising:
determining whether or not communication failure occurs in second data communication between the cable and an external apparatus connected via a port connected with the cable, and
turning off a switch corresponding to a port connected with an external apparatus where communication failure occurs in the second data communication via the cable when it has been determined that communication failure occurs in the second data communication.

7. A control method of an electronic apparatus having functions to perform first data communication and second data communication, where the electronic apparatus comprising:
a plurality of ports configured to be inserted a one end of a cable having a first signal line for performing first data communication and a second signal line, respectively, other end of the cable inserted into a port provided in the external apparatus having a function to perform at least first data communication;
a communication module which performs the second data communication between the communication module and the external apparatus which can perform the second data communication via a cable connected to any port of the plurality of ports;
a communication module configured to perform the second data communication via the cable whose one end being inserted into any port of the plurality of ports with an external apparatus having a function to perform the second communication;
a communication line configured to connect the second signal line in the cable whose one end inserted into the each port and the communication module with each other in a wired-OR manner; and
a plurality of switches provided on the communication line, and configured to perform switching between on and off of electrical connection between the second signal line in the cable connected to the each port and the communication module independently, and
the control method comprising:
displaying a setting screen for setting on or off of the each switch on a display device;
detecting setting of on or off of the each switch which a user uses the setting screen to input; and
performing switching between on and off of the each switch according to the setting detected.
